(19) United States
(12) Patent Application Publication
(10) Pub. No.: US 2007/0205111 A1
(43) Pub. Date: Sep. 6, 2007

(54) Apparatus And Method For Producing Hydrogen

(75) Inventor: Ronald C. Bayliss, Altadena, CA (US)

Correspondence Address: CONNOLLY BOVE LODGE & HUTZ LLP, P.O. BOX 2207, WILMINGTON, DE, 19899, US

(73) Assignee: NANSCOPIC TECHNOLOGIES, INC.

(21) Appl. No.: 11/555,118

(22) Filed: Oct. 31, 2006

Related U.S. Application Data
(60) Provisional application No. 60/731,263, filed on Oct. 31, 2005.

(51) Int. Cl. C25B 1/02

(52) U.S. Cl. 205/637

(57) ABSTRACT

An apparatus and method for producing hydrogen is disclosed. A housing includes a conversion compartment fluidly connected to a gas collection compartment. A filter is disposed between the conversion compartment and the gas collection compartment. The filter is permeable to select molecules, such as hydrogen and oxygen. An energizer module is adapted to generate an oscillating signal. A piezo electric ceramic element is disposed within the conversion compartment and is electronically coupled to the energizer module to receive the oscillating signal. The piezo electric ceramic element preferably comprises a substrate and a piezo electric ceramic membrane affixed to the substrate.

### PRIORITY

Priority is claimed to U.S. Provisional Patent Application Ser. No. 60/731,263, filed on Oct. 31, 2005, the disclosure of which is incorporated herein by reference in its entirety.

### BACKGROUND OF THE INVENTION

1. Field of the Invention

The field of the present invention is systems and methods for producing hydrogen from other molecules, particularly water.

2. Background

It has long been recognized that hydrogen gas can be used as a fuel for internal combustion engines and fuel cells. Where hydrogen has been produced commercially, as for example from a steam/colte process or as a by-product from the chlor-alkali industry, containing the produced gas is difficult and costly. As the gas is initially under high pressure, a very strong heavy container is required to maintain a significant volume of gas under pressure, a limitation for portable use. Similarly, to contain hydrogen in a liquid state also requires a strong and therefore heavy containment vessel, again limiting use as a portable supply.

Processes have been proposed for many years in which controlled energy producing reactions of diatomic particles are projected to occur under “cold” conditions. An example of research in to this matter was published in the Scientific American in July of 1997 by J Rafelski, and S. E. Jones entitled “Cold Nuclear Fusion.”

Recently the interest in hydrogen generation has increased because of new developments in fuel cells, specifically proton exchange membrane (PEM) fuel cells. The combination of these cells with a hydrogen generator offers considerable advantages over primary and secondary batteries and cryogenic tanks for storage of hydrogen in terms of gravimetric and volumetric energy density and life cycle cost and safety.

Fossil fuels or their derivatives, such as natural gas or methanol, are currently converted to hydrogen for use in fuel cells by means of a complicated set of bulky components: a reformer (to convert the fossil fuel to a mixture of hydrogen, carbon dioxide, carbon monoxide and water vapor); a shift converter (to remove most but not all of the carbon monoxide); and one or more gas purifiers (needed if the hydrogen is to be used in a PEM or an alkaline fuel cell or stored as a metal hydride). The fuel cells that do not need a gas purifier, such as phosphoric acid fuel cells, are the heaviest and largest. A fuel cell that is relatively lightweight and compact, e.g. a PEM or alkaline fuel cell, generally needs an energy intensive, complicated, delicate, and expensive purifying apparatus to utilize hydrogen.

There are inherent difficulties with hydrogen and natural gas storage in an environment such as automobiles. It is either too voluminous (at low pressure) or too heavy (because of the tank or cylinders needed at high pressure). When maintained in a liquid state, the energy needed to cryogenically keep the hydrogen liquid is expensive and energy consuming. Moreover, both storage systems are potentially unsafe because of the potential combustibility of the hydrogen in pressurized large volumetric quantities.

Storage of hydrogen as a metal hydride is also expensive since metal alloys suitable for hydrogen storage in readily reversible metal hydrides are expensive to fabricate and because they require the hydrogen to be free of carbon monoxide, carbon dioxide, and water vapor. Regeneration of such metal hydrides is also a problem because it requires pure hydrogen, which is generally more costly than reformed natural gas. Reformed natural gas, which is an alternative regenerative to pure hydrogen, is comparatively inexpensive but contains impurities such as carbon dioxide and steam. Adding to the regeneration expense is the continuous supply of external cooling that is needed to drive the regeneration reaction. Of late, it has been suggested that hydrogen be stored as H₂SO₄ and reacted with scrap iron to produce hydrogen. This approach has so far proven to be costly, and the added weight of the sulfuric acid has further limited its use.

The reaction of iron with water (steam) to produce iron oxide and hydrogen is well known. Though, the conversion rate of the reaction is extremely low unless the water has been heated to extremely high temperatures. This results in a low overall efficiency and thus has no current practical commercial value.

One attempt at creating a hydrogen generating system based upon the reaction is disclosed in U.S. Pat. No. 4,547,356 (Papineau), which suggests that hydrogen, may be generated by the catalytic decomposition of steam at temperatures of 1,000°-2,000° F. (540°-1,094° C.) to form hydrogen and oxygen. The teachings of this patent, however, do not appear to have met with any success, commercial or otherwise.

Hydrogen generators have long been used to generate hydrogen through the hydrolysis of chemical hydrides, and in particular, metal hydrides. For example, U.S. Pat. No. 2,334,211 discloses a hand-held generator containing calcium hydrides which, when submersed in water, produces sufficient hydrogen to fill an emergency signal balloon.

More recently, the most common portable source of hydrogen is hydrogen bottles or tanks in which the hydrogen is stored under pressure. The hydrogen stored in these bottles or tanks is generated at a hydrogen production plant, shipped as a cryogenic liquid, vaporized, and expanded into the tanks or bottles under pressure. These hydrogen tanks or bottles are generally bulky and rather heavy. Further, when a tank or bottle is exhausted, it must be replaced with another tank or bottle. Storage tanks or bottles are utilized in field applications because, typically, hydrogen production facilities have been considered too large, too heavy, too expensive, and in many instances, too unsafe, for portable operation. In response there have been attempts to develop practical and portable hydrogen generators.

One such portable hydrogen generator is disclosed in U.S. Pat. No. 4,155,712. This portable hydrogen generator utilizes a metal hydride and water vapor to produce hydrogen on demand or at a constant pressure feed over widely varying demand rates without water supply contamination or metal hydride caking complications. Among the problems in the use of demand responsive hydrogen generators, however, is that sudden requirements made on the water vapor can cause water, instead of water vapor, to be drawn into direct contact with the fuel, thus causing a malfunction.

U.S. Pat. No. 4,261,955 addresses this problem by utilizing a wall for separating adjacently disposed solid fuel and water compartments. The wall includes two spaced apart porous hydrophobic membranes. During normal production of hydrogen gas, the membranes are of a character as to normally only pass water vapor from the water supply to the fuel compartment if an abnormal demand is made on the water vapor, it could inadvertently cause un-vaporized water to pass through one of the membranes. Therefore, a hydrogen gas outlet must be positioned between the spaced-apart membranes to pull off the water before it can reach the metal hydride fuel.

Together U.S. Pat. Nos. 4,155,712 and 4,261,955 reveal using compounds with a chemical hydride, such as lithium aluminum hydride (LiAIH₄) in an attempt to control internally generated heat. Currently, however, no commercially feasible small portable hydrogen generators are able to immediately supply and sustain a constant flow of hydrogen while controlling external structural heating and escalating temperatures and pressures in the generator due to uncontrolled hydrogen release by the chemical hydride. As a result, industry characteristically still uses high-pressure gas storage, metal hydride storage, or liquid hydrogen for a hydrogen gas supply.

U.S. Pat. No. 4,394,230 describes a way to produce hydrogen via electrolyzing the water molecules utilizing alternating current. A salt solution is added to the water to enrich and aid conductivity during the electrolysis process. This “resonance” however is achieved through control of other factors, mainly the molal (designating a solution containing one mole of solute per 1000 grams of solvent) concentration of salt in the water. This is controlled by measuring the conductivity of the water through the built in current meter. An ideal ratio of current to voltage is maintained which is an index to the optimum salt concentration.

U.S. Pat. No. 4,421,474 utilizes high voltage resonant cavities in what it is suggested as an over unity configuration. This method also uses “electrolysis” (electrolyzing process to separate the H₂O). More recent patents disclose generators for the production of hydrogen from methanol (U.S. Pat. Nos. 5,172,052 and 5,885,727). However, a by-product of this process is carbon monoxide, which is adsorbed by the catalyst. This causes “catalyst poisoning”, which refers to the deterioration of the catalytic function of the electrode, and subsequent lowering in the energy efficiency of the system. In order to minimize this problem, such generators must necessarily be equipped with means for measuring an decreasing the carbon monoxide concentration in the system.

Another example is disclosed in U.S. Pat. No. 4,613,304, U.S. Pat. No. 367,051 and U.S. Pat. No. 302,807, each of which discloses variations of a hydrogen gas generator system for converting water into hydrogen and oxygen gasses. The hydrogen gas generator encompasses an array of plates immersed in a housing with natural water pass through the system. Direct current, voltage dependant/current limited, potential applied to the plates causes the hydrogen/oxygen gasses to disassociate from the water molecule.

Other examples of attempts to produce reliable hydrogen fuel abound. However, none have yet found the balance between efficiency in producing hydrogen and cost efficiency.

Different types of fuel cells are also known. For example, U.S. Pat. No. 5,200,278 entitled “Integrated Fuel Cell Power Generation System,” assigned to Ballard Power Systems, Inc., and incorporated herein by reference, describes one embodiment of a fuel cell useful as a power source. However, like production of hydrogen fuel, no single type of fuel cell has yet found the balance between sustained, efficient energy production and cost efficiency.

Polymer electrolyte fuel cell (PEFC) or proton exchange membrane fuel cells (PEMFC) are sensitive to fuel impurities and require an external reformer. Water management in the membrane is critical for efficient performance because the membrane has to be hydrated.

Alkaline fuel cells (AFCs) were one of the first fuel cell technologies developed, and they were the first type widely used in the U.S. space program to produce electrical energy and water onboard spacecraft. The disadvantage of this fuel cell type is that it is easily poisoned by carbon dioxide (CO₂) and requires an external reformer.

Molten carbonate fuel cells (MCFC) are currently being developed for natural gas and coal-based power plants for electrical utility, industrial, and military applications. MCFCs need to be resistant to impurities from coal, such as sulfur and particulates. The primary disadvantage of current MCFC technology is durability. The high temperatures at which these cells operate and the corrosive electrolyte used accelerate component breakdown and corrosion, decreasing cell life.

Solid oxide fuel cells (SOFC) operate at very high temperatures, around 1,000° C. (1,830° F.). High-temperature operation has disadvantages it results in a slow startup and requires significant thermal shielding to retain heat and protect personnel. SOFCs may therefore be acceptable for utility applications, but not for transportation and small portable applications. The development of low-cost materials with high durability at cell operating temperatures is the key technical challenge facing this technology.

Phosphoric acid fuel cells (PAFC) use liquid phosphoric acid as an electrolyte. The PAFC is considered the “first generation” of modern fuel cells. This is only slightly more efficient than combustion-based power plants, which typically operate at 33 to 35 percent efficiency. PAFCs are also less powerful than other fuel cells, given the same weight and volume, resulting in these fuel cells typically being large and heavy. PAFCs are also expensive. Like PEMFCs, PAFCS require an expensive platinum catalyst, which raises the cost of the fuel cell.

The fuel cell powered automobile is currently under concentrated development due to the twin needs to reduce air pollution and to conserve fossil fuel resources. One of the major difficulties in the development of the electric automobile is supplying the power for the electric drive motors, typically furnished by batteries. Present battery technology, however, is not capable of providing the energy needed to run the automobile over extended distances at an affordable cost. Also, the use of PEMFC technology to generate the electrical power to drive the electric motors is neither cost effective nor totally environmentally friendly. The range of such vehicles is largely determined by the size of the pressurize hydrogen tanks placed typically in the trunk of the vehicle and often cryogenically cooled. Thus at present there is no technology that is affordable and viable as a true alternative to fossil based fuels that can be implemented, within a reasonable time frame, to change over from fossil fuels to a new alternative energy source.

### SUMMARY OF THE INVENTION

The present invention is directed toward an apparatus and method for producing hydrogen. A housing includes a conversion compartment into which a piezo electric ceramic element is placed. Water is then placed into the conversion compartment, and the piezo electric ceramic element is energized to break down the covalent bonds of water molecules, thereby generating hydrogen in gaseous form.

In a first separate aspect of the present invention, the piezo electric ceramic element disposed within the conversion compartment is electronically coupled to an energizer module. The energizer module generates an oscillating signal which is transmitted to and drives the piezo electric ceramic element.

In a second aspect of the present invention, which builds upon the first separate aspect, the piezo electric ceramic element comprises a substrate and a piezo electric ceramic membrane affixed to the substrate. The oscillating signal may be used to drive both the substrate and the piezo electric ceramic membrane. Alternatively, the substrate may be driven using a first oscillating signal and the piezo electric ceramic membrane may be driven using a second oscillating signal.

In a third separate aspect of the present invention, the housing includes a gas collection compartment fluidly connected to the conversion compartment. A filter which is permeable to select molecules is disposed between the two compartments, thereby permitting the select molecules to pass from the conversion compartment into the gas collection compartment.

In a fourth aspect of the present invention, which builds upon the third separate aspect, the gas collection compartment includes a hydrogen filter disposed within a first outlet port and an oxygen filter disposed within a second outlet port. These ports may be used to remove hydrogen and oxygen from the gas collection chamber.

In a fifth separate aspect of the present invention, the housing includes a water intake valve fluidly connecting the conversion compartment to an external water source.

In a sixth separate aspect of the present invention, a plurality of piezo electric ceramic elements are disposed within the conversion compartment. The piezo electric ceramic elements are electronically coupled to an energizer module, which is adapted to generate one or more oscillating signals, such that each piezo electric ceramic element is driven by at least one of the oscillating signals.

In a seventh separate aspect of the present invention, a command and control module is included to monitor the apparatus through a plurality of sensors and to regulate operation of the apparatus and the production of hydrogen.

In an eighth separate aspect of the present invention, any of the foregoing aspects may be employed in combination.

Accordingly, an improved apparatus and method for producing hydrogen are disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1A is a schematic diagram of a hydrogen generating apparatus;

FIG. 1B is a sectional view of power and data lines used in a hydrogen generating apparatus;

FIG. 2 is schematic diagram of the hydrogen generating apparatus of FIG. 1A, including details for the energizer module;

FIG. 3A is a top elevation view of a first piezo electric ceramic element;

FIG. 3B is a side view of the piezo electric ceramic element of FIG. 3A;

FIG. 4A is a top elevation view of a second piezo electric ceramic element;

FIG. 4B is a side view of the piezo electric ceramic element of FIG. 4A;

FIG. 5A is a side view of a third piezo electric ceramic element;

FIG. 5B is a perspective view of the piezo electric ceramic element of FIG. 5A;

FIG. 6 is a perspective view of a stack of piezo electric ceramic elements;

FIG. 7 is a schematic diagram of a hydrogen generating apparatus installed in a vehicle.

### DETAILED DESCRIPTION OF THE PREFERRED EMBODIMENTS

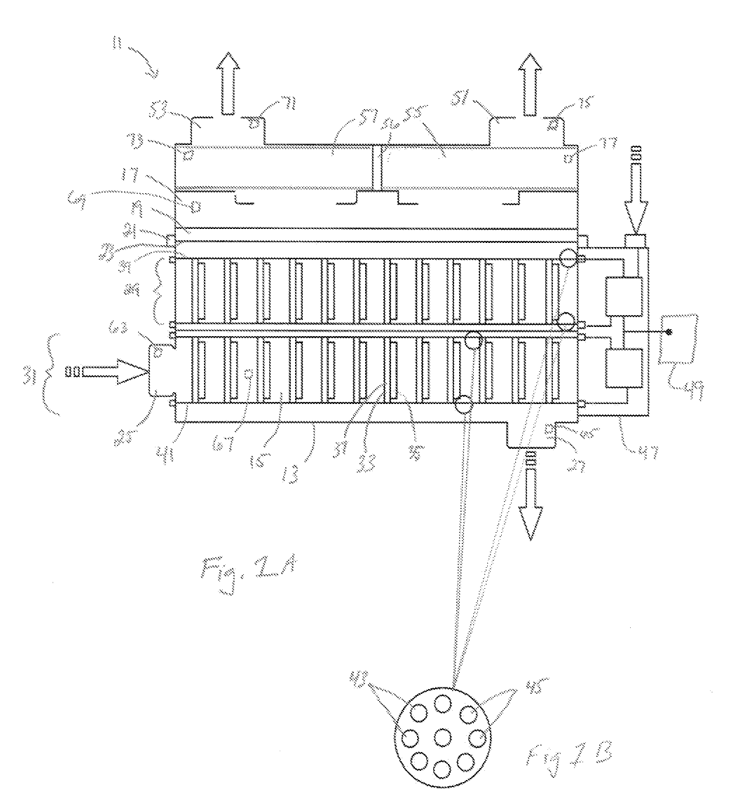

Turning in detail to the drawings, FIG. 1 illustrates a molecular hydrogen generator (MHG) 11 which has a housing 13 that is divided into two compartments, a conversion compartment 15 and a gas collection compartment 17. The housing is preferably constructed from a waterproof material such as Plexiglas, ABS plastic, or other similar materials that exhibit strength, excellent waterproof qualities, resistance to distortion of structure, and decay. The gas collection compartment 17 is separated from the conversion compartment 15 by a filter 19 which is impermeable to water but permeable to gases such as hydrogen and oxygen. The two compartments 15, 17 are sealed together in a watertight arrangement though the use of locks 21 and a gasket 23. The gasket 23 may be any type of appropriate material, such as Neoprene, synthetic rubber, silicone, Teflon®, or any other appropriate material known to the skilled artesian.

The conversion compartment 15 includes a water intake valve 25 and a water drainage valve 27. Two stacks of piezo electric ceramic elements 33, an upper stack 29 and a lower stack 31, are disposed within the conversion compartment 15. Each stack 29, 31 includes several piezo electric ceramic elements 33, with each element 33 having a piezo electric ceramic membrane 35 mounted on a substrate 37. The substrate 29 may be any standard material, such as metal, with a piezo ceramic membrane mounted thereto. Such piezo electric ceramic elements are known to those skilled in the art and are presently used for purposes other than for generating hydrogen as is described in further detail below.

The number of piezo electric ceramic elements in either of the stacks may vary from one to many, limited primarily by the size of the housing 13, depending upon the volume of hydrogen desired as output from the MHG. In addition, single stack of piezo electric elements, or more than two stacks, may be employed in the MHG.

The upper stack 29 is supported within the conversion compartment 15 by an upper support structure 39, and the lower stack 31 is supported by a lower support structure 41. Additional reinforcement structure may be provided as needed depending upon the use for which the MHG is intended. As is shown in FIG. 1B, power lines 43 and data transmission lines 45 are run along the upper and lower support structures 39, 41 to provide power and data signals to the piezo electric ceramic elements 33 in each of the upper and lower stack 29, 31, respectively, from the energizer module 47 and the command and control module 49.

The collection compartment 17 includes an oxygen outlet port 51 and a hydrogen outlet port 53 through which oxygen and hydrogen, respectively, are drawn. The oxygen and hydrogen are separated by two gas permeable filters. The first is the oxygen filter 55, which is disposed within the collection compartment 17 in front of the oxygen outlet port 51. The second is the hydrogen filter 57, which is likewise disposed within the collection compartment 17 in front of the hydrogen outlet port 53. The oxygen filter 55 and the hydrogen filter 57 are preferably microporous membranes which are permeable only to the respective gasses. Such membranes, along with other methods for gas filtration, are readily available to and known to those skilled in the art. Pumps may be used to draw hydrogen and oxygen through the respective filter. Alternatively, or in combination, pressure from the gas entering the collection compartment 17 may be used to force gases through the filters 55, 57. A gas impermeable divider 56 separates the oxygen filter 55 and the hydrogen filter 57. Internal ports 59, 61 remain open so that oxygen and hydrogen gas can pass into the oxygen filter 55 and hydrogen filter 57, respectively.

Operation of the stacks 27, 29 and the filters 55, 57 is controlled by the command and control module 49, and the piezo electric ceramic elements 30 in each stack 27, 29 are driven by the energizer module 47. The command and control module 49 is preferably a programmable CPU which may be programmed to effect the desired operation of the MHG 11, through adjustments made to the various pumps, filters, and the energizer module 47, according to preprogrammed parameters. To this end, the command and control module 49 monitors various sensors disposed throughout the MHG 11. For example, if one piezo electric ceramic element 33 fails, the remaining piezo electric ceramic elements 33 keep working, and the command and control module 49 notifies the user that the failure has occurred and maintenance is required. By way of another example, if the water level within the conversion compartment 15 falls below a predetermined level, the command and control module 49 activates the water intake valve 25 to enable additional water to flow into the conversion compartment 15 from an external source. The command and control module 49 similarly monitors all sensors and is preprogrammed with appropriate responses in the event any sensor reports a fault.

An inlet sensor 63 is disposed at the water intake valve 25 so that water flow and functioning of the water intake valve 25 can be monitored. A water drainage sensor 65 is disposed at the water drainage valve 27 so that the water drainage valve 27 may be monitored for leakage during operation of the MHG 11. A conversion compartment sensor 67 is disposed within the conversion compartment 15 to monitor water levels, water temperature, and the condition of the various piezo electric ceramic elements 33 within the conversion compartment 15. A collection compartment sensor 69 is disposed within the collection compartment 17 to monitor the amount of disassociated gas within the collection compartment 17. A hydrogen sensor 71 is disposed at the hydrogen outlet port 53 so that the amount of hydrogen produced by the MHG 11 may be monitored. A hydrogen filter sensor 73 is disposed at the hydrogen filter 57 so that proper functioning of the hydrogen filter 57 may be monitored during operation of the MHG 11. An oxygen sensor 75 is disposed at the oxygen outlet port 51 so that the amount of oxygen produced by the MHG 11 may likewise be monitored. An oxygen filter sensor 77 is disposed at the oxygen filter 51 so that proper functioning of the oxygen filter 51 may be monitored during operation.

The command and control module 49 may be any type of computational device sufficient to carry out the necessary tasks. Examples of such computational devices are microprocessors, microcomputers, minicomputers, optical computers, board computers, complex instruction set computers, ASICs (Application Specific Integrated Circuit), reduced instruction set computers, analog computers, digital computers, molecular computers, quantum computers, superconducting computers, supercomputers, solid-state computers, single-board computers, buffered computers, computer networks, desktop computers, laptop computers, scientific computers, and the like, or combinations or hybrids of any of the foregoing.

In addition to being coupled to internal sensors, the command and control module 49 may also be coupled to external computer networks such as a vehicle control systems, engine emission control systems, and the like. Such peripheral systems would be configured to communicate with the command and control module 49 using well-known computer communications protocol, such as TCP/IP (Transmission Control Protocol/Internet Protocol), ModBus, or RS-232.

The energizer module 47, shown in more detail in FIG. 2, generates two oscillating signals which are used to drive the piezo electric ceramic elements 31. It should be appreciated that the energizer module 47 design shown herein serves as an example only and that many variations of the circuitry design will be evident to the skilled artesian. The energizer module 47 includes two oscillators 81, 83 to enable it to produce two oscillating signals. The pulse amplitude generator 85, pulse width generator 89, and frequency processing unit 91 help condition and shape the oscillating signals fed into the variable switching circuit 93, which serves to vary the frequencies of the oscillating signals in accordance with data transmitted by the command and control module 49. From the variable switching circuit 93, the oscillating signals are transmitted to the piezo electric ceramic elements 33. Power to the energizer module 47 is supplied from an external power source 95 through a fuse 97 and a voltage regulator 99. A back up battery 101 is also included in the event the external power source 95 fails.

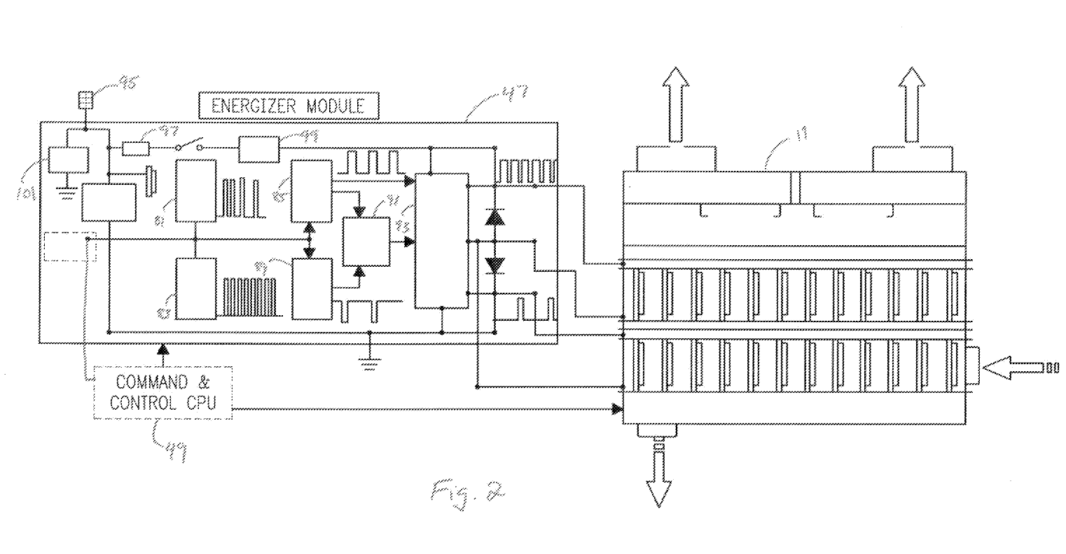

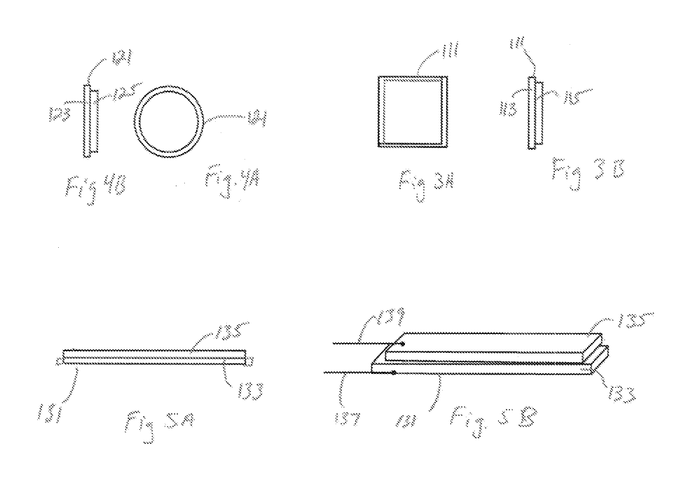

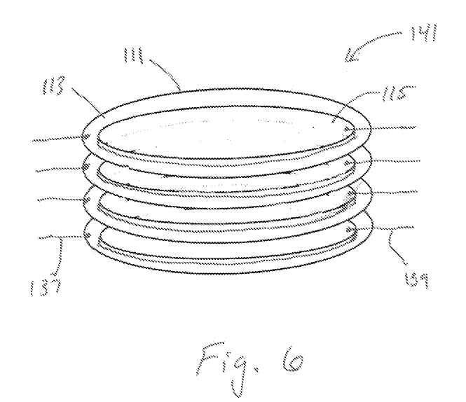

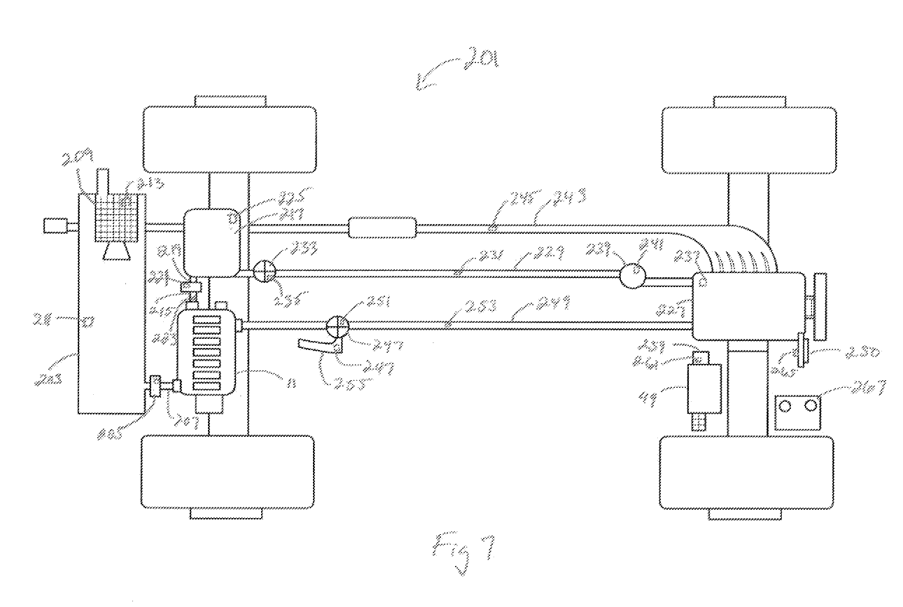

The next set of figures shows various configurations for the piezo electric ceramic elements, which may have virtually any geometrical configuration and size, although some configurations or sizes may be better suited for being driven at select frequencies. FIG. 3A & 3B show a piezo electric ceramic element 111 in which both the substrate 113 and ceramic membrane 115 are square. FIG. 4A & 4B show a piezo electric ceramic element 121 in which both the substrate 123 and ceramic membrane 125 are round. FIG. 5A & 5B show a piezo electric ceramic element 131 in which both the substrate 133 and ceramic membrane 135 are rectangular. FIG. 5B shows two electrical leads 137,139, one connected to the substrate 133 and the other connected to the ceramic membrane 135. The oscillating signals are transmitted through these electrical leads 137,139 to drive the substrate 133 and the ceramic membrane 135, respectively, at the desired frequencies. FIG. 6 illustrates a stack 141 of four round piezo electric ceramic elements 111. A first set of electrical leads 137 are connected to each of the substrates 113, and a second set of electrical leads 139 are connected to each of the ceramic membranes 115.

Operation of the MHG 11 described above is preferably wholly controlled by the command and control module 49. Water intake into the conversion compartment 15 is controlled by the command and control module 49 using the water intake valve 25 and the inlet sensor 63. Water levels within the conversion compartment 15 are monitored at all times during operation. The water level within the conversion compartment 15 typically should not fall below the top of the upper stack 29. Should the water level fall below the upper stack 29, the command and control module 49 may independently turn off operation of the upper stack 29, while maintaining operation of the lower stack 31. If the MHG 11 is connected to a water source, water may be drawn into the conversion compartment 15 through the water intake valve 25. When sufficient water is in the conversion compartment 15, any deactivated stacks may be reactivated so that normal operation may proceed.

Additional redundancy may be built into the stack configuration to avoid complete failure of the MHG 11. For example, the MHG 11 may include four or eight stacks total so that drops in water levels only affect the top most stacks, while all the lower stacks can continue to produce hydrogen. The number of redundant stacks, or even the need for redundancy, is dependent upon the final use. For example, when used to power a machine with an operator at close proximity, or a non-critical machine that can be shut down, the redundancy may not be necessary.

The oscillating signals generated by the energizer module 47 will generally have a frequency between, 5 Hz to 200 MHz, although frequencies outside this range may also be used. For example, oscillating signals with frequencies up to and in excess of 500 kHz may be used. However, frequencies greater than 500 kHz may require that the water in the conversion compartment 15 have a temperature at or below 100° F. In general, the frequency range used for any particular MHG unit will dependent upon several factors, including the specific configuration and the output demand requirement. Moreover, the frequency of the oscillating signals may be static during operation, or they may be dynamically changed by the command and control module 49 to accommodate demands placed on the MHG 11 during operation.

The oscillating signals created by the energizer module 47 are applied to the piezo electric ceramic membranes 35 and to the substrates 37. These signals are preferably applied at a predetermined frequency which is set for optimal performance based upon the configuration of the MHG 11. Also, depending upon the configuration of the MHG 11 and the output demand requirements, all the piezo electric ceramic elements 33 may be driven at the same frequency, or alternatively, different groupings or stacks of the piezo electric ceramic elements 33 may be driven at different frequencies. The use of two or more frequencies enables greater control over the hydrogen production process in the MHG 11. For example, in the event that one stack fails, the remaining functional stacks may be driven with oscillating signals having higher frequencies to compensate for the one failure. In addition, although not typical, the piezo electric ceramic membrane 35 and the substrate 37 of the piezo electric ceramic elements 33 may be driven at different frequencies.

By driving the piezo electric ceramic elements 33 with the oscillating signals, each piezo electric ceramic element 33 becomes a dual oscillator and generates micro electromechanical vibrations. The vibrations serve to break the covalent bonds of the water molecule disassociate the hydrogen from the oxygen some wattage ranges that may be used for the disassociation are:

Supplied energy 12Volts at 500 mA=6 Watts;

Supplied energy 12 Volts at 1000 mA=12 Watts;

Supplied energy 12 Volts at 250 mA=3 Watts; and

Supplied energy 12 Volts at 150 mA=1.8 Watts.

The disassociation can be expressed stoichiometrically as 2H₂O+e=2H₂(g)+0₂(g), where e is the energy required to drive the disassociation of the hydrogen/oxygen molecules and (g) indicates that the molecule is in a gaseous state. The energy required for the dissociation is typically, at 12 Volts, in the range of 200-500 mA, although up to 2 Amps or more may be used, and as little as 150 mA or less may also be used. Of course, the amount of supplied current will vary depending upon the voltage used.

The process underlying molecular disassociation from the micro electro-mechanical vibrations is not wholly understood. The actual process taking place to cause disassociation of the molecules is largely an effect of the high frequency vibrations brought about by the oscillating signals generated in the energizer unit. The process may be enhanced through pulsed light or electromagnetic radiation to further agitate and excite the molecules and facilitate the disassociation process.

Turning to FIG. 7, an MHG 11, along with it's command and control module 49, is shown incorporated into the chassis of a motor vehicle 201. While use of the MHG is described in connection with a motor vehicle, in practice the MHG can be used with any mechanical device that is motivated by or generates energy from any type of hydrogen consuming engine or power (electrical or mechanical) generator. A water storage tank 203 is connected to the water intake valve 25 of the MHG 11 through a water pump 205 and a water supply pipe 207. A water filter 209 is included within the water storage tank 203 to remove contaminants from water as it is placed into the water storage tank 203. Preferably, the water filter 209 uses a combination activated carbon/mixed resin bed to remove any contaminants, whether from external or internal sources.

As with the MHG 11 unit itself, a water supply sensor 211 is used to monitor the level of water within the water storage tank 203. Preferably, an easily visible indicator notifies the user that the water level has dropped and that water needs to be added. Also, in order to avoid damage to the system, operation of the MHG is preferably shut down when water in the water storage tank 203 reaches a predetermined lower level. Similarly, a water filter sensor 213 is used to monitor the water filter 209 so that the user can be notified when the water filter 209 requires replacement or cleaning. Preferably, the command and control module 49 is connected to a display within the motor vehicle, one that is easily visible to the operator, so that the status of sensors associated with the MHG 11, and operation of the MHG 11 in combination with the motor vehicle 201, may be relayed to the operator.

Hydrogen and oxygen produced from the disassociation process exits the MHG 11 and is directed through the hydrogen supply pipe 215 and into the hydrogen reservoir tank 217 by the hydrogen gas pump 219. A hydrogen gas pump sensor 221 monitors the status and flow of the hydrogen through the hydrogen gas pump 219. A hydrogen gas supply pipe sensor 223 monitors the flow of the hydrogen through the hydrogen gas supply pipe 215 as it leaves the MHG 11. This monitoring ensures that hydrogen is being produced at the appropriate rate and that there are no failures in the system to that point.

The hydrogen reservoir tank 217 is dimensioned to store sufficient hydrogen to run the motor vehicle 201 for a short period and to start the engine from cold. Preferably, the hydrogen storage tank 217 stores hydrogen at between 100% and 80% of its capacity at any given time. The hydrogen reserve tank sensor 225 monitors the level of hydrogen within the hydrogen storage tank 217. When the hydrogen level falls below the predetermined density in the hydrogen storage tank 217, the MHG 11 resumes production of hydrogen. The hydrogen reserve tank sensor 225 may also provide statistics regarding hydrogen consumption, and these statistics may be compared with predetermined operational parameters to help ensure proper operation of the MHG 11 and the motor vehicle 201.

Hydrogen flows from the hydrogen reserve tank 217 to the internal combustion engine 227 via a hydrogen gas flow pipe 229, which is monitored by the hydrogen flow pipe sensor 231. The hydrogen control pump 233, which is regulated by the hydrogen control pump sensor 235, pulls hydrogen from the hydrogen reserve tank 217 to fill the demand created by the internal combustion engine 227. For safety purposes, a backup hydrogen pump 239, along with a backup hydrogen pump sensor 241, is included for redundancy. Fuel requirements of the engine 227 are monitored by the engine sensor 237. Additional sensors may be placed to monitor the standard mechanical parts of the motor vehicle, i.e., the drive train, the axels, and the like, to help ensure these parts remain operating within predefined operational parameters.

Exhaust from the internal combustion engine 227 is released via the exhaust pipe 239 and dispersed into the atmosphere. The exhaust pipe 243 is monitored by the exhaust sensor 245, which monitors the exhaust temperature and the composition of the exhaust gases.

An oxygen gas pump 247 pulls oxygen gas from the MHG 11 through the oxygen gas flow pipe 249. The oxygen gas pump 247 is monitored through an oxygen gas pump sensor 251, and the oxygen gas flow pipe 249 is monitored through the oxygen flow pipe sensor 253. The oxygen gas pump 247 includes an oxygen outlet 255 which may be used to release oxygen into the atmosphere. An oxygen outlet sensor 257 monitors the quantity of oxygen emitted through the oxygen outlet 255. The oxygen gas flow pipe 249 leads in to the internal combustion engine 227 so that the oxygen may be used to enhance combustion. Incorporation of the oxygen outlet 255 into the oxygen gas pump 247 enables the oxygen to be either used to enhance combustion or released in to the atmosphere.

The oxygen gas pump sensor 251 indicates a pass/fail when diverting oxygen gas to either the internal combustion engine 227 or to the atmosphere. If the oxygen gas pump 247 fails partially open, it is possible that the oxygen gas pump sensor 251 would not recognize the failure until the oxygen gas pump 247 is instructed to close. This failure can be detected by the oxygen gas pipe sensor 253 and the oxygen gas vent sensor 257, both which monitor the quantity of gas traveling through the oxygen gas pipe 249 and being vented to the atmosphere. By operating in this manner, the operator may be alerted to the failure before the next time the oxygen gas pump 247 changes state.

The ability to switch between releasing the oxygen to the atmosphere and directing it into the engine may provide value for certain internal combustion engine formats when the combustion chamber is under extreme loading conditions. By directing the oxygen to the internal combustion engine, the combustion process is enhanced, thus providing more power than would is required under normal running conditions. Depending upon the programming to the command and control module, the system could redirect into the internal combustion engine during operation. Alternatively, this redirection could be a feature over which the operator is provided manual control.

A backup battery 259 is connected through power lines (not shown) to all sensors, pumps, and to MHG 11 itself to provide power redundancy. The backup battery 259 includes a battery sensor 261 that notifies the user when the battery 259 requires either replacement or recharging. It should be noted that any type of battery or other appropriate power source may be used.

Typically, the backup battery 259 is smaller (6-12 volt), although a larger battery could be used. In addition to the above mentioned emergency function, the backup battery 259 powers and maintains the integrity of the command and control module 49. This enables the system to monitor functions even while the vehicle is stationary and the engine 227 is not generating any power.

Under normal operating conditions, the MHG 11 is powered by an alternator 263, or alternatively an additional small fuel cell could be used. The alternator 263 is monitored by an alternator sensor 265, which monitors the working condition of the alternator 263. The car battery 267 is used to initiate the hydrogen generating process of the MHG 11. Once the internal combustion engine is running, all power for the MHG 11 is derived from the alternator 250.

Also during start up, the hydrogen reserve tank 217 preferably has a sufficient store of hydrogen to immediately supply to the engine 227. This system is an on-demand, on-board molecular hydrogen generation system, so as long as a steady hydrogen production rate is maintained by the MHG 11, the hydrogen reserve tank 22 will remain full. Operation in this manner puts very little demand or stress on the existing electrical power systems of the vehicle.

Thus, an apparatus and method for producing hydrogen are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A hydrogen production apparatus comprising:
a housing including a conversion compartment fluidly connected to a gas collection compartment;
a filter disposed between the conversion compartment and the gas collection compartment, wherein the filter is permeable to select molecules;
an energizer module adapted to generate an oscillating signal;
a piezo electric ceramic element disposed within the conversion compartment and electronically coupled to the energizer module to receive the oscillating signal.

2. The apparatus of claim 1, wherein the piezo electric ceramic element comprises:
a substrate; and
a piezo electric ceramic membrane affixed to the substrate.

3. The apparatus of claim 2, wherein both the substrate and the piezo electric ceramic membrane are electronically coupled to the energizer module to receive the oscillating signal.

4. The apparatus of claim 1 further comprising a hydrogen filter disposed in a first outlet port of the gas collection compartment.

5. The apparatus of claim 1 further comprising an oxygen filter disposed in a second outlet port of the gas collection compartment.

6. The apparatus of claim 1, wherein the conversion compartment is watertight.

7. The apparatus of claim 6 further comprising a water intake valve fluidly connecting the conversion compartment to an external water source.

8. The apparatus of claim 6 further comprising a water drainage valve.

9. The apparatus of claim 1, wherein the select molecules include hydrogen molecules (H₂) and oxygen molecules (O₂).

10. A hydrogen production apparatus comprising:
a housing including a conversion compartment fluidly connected to a gas collection compartment;
a filter disposed between the conversion compartment and the gas collection compartment, wherein the filter is permeable to select molecules;
an energizer module adapted to generate one or more oscillating signal;
a plurality of piezo electric ceramic elements disposed within the conversion compartment, each piezo electric ceramic element being electronically coupled to the energizer module to receive one of the oscillating signals.

11. The apparatus of claim 10, wherein each piezo electric ceramic element comprises:
a substrate; and
a piezo electric ceramic membrane affixed to the substrate.

12. The apparatus of claim 11, wherein both the substrate and the piezo electric ceramic membrane are electronically coupled to the energizer module to receive one of the oscillating signals.

13. The apparatus of claim 12, wherein both the substrate and the piezo electric ceramic membrane receive the same oscillating signal.

14. The apparatus of claim 10, wherein the plurality of piezo electric ceramic elements are arranged into a plurality of stacks.

15. The apparatus of claim 14, wherein one of the stacks receives a first oscillating signal from the energizer module and the other stacks receive a second oscillating signal from the energizer module.

16. The apparatus of claim 10 further comprising a hydrogen filter disposed in a first outlet port of the gas collection compartment.

17. The apparatus of claim 10 further comprising an oxygen filter disposed in a second outlet port of the gas collection compartment.

18. The apparatus of claim 10, wherein the conversion compartment is watertight.

19. The apparatus of claim 18 further comprising a water intake valve fluidly connecting the conversion compartment to an external water source.

20. The apparatus of claim 18 further comprising a water drainage valve.

21. The apparatus of claim 10, wherein the select molecules include hydrogen molecules (H₂) and oxygen molecules (O₂).

22. A method of producing hydrogen, the method comprising:
placing a piezo electric ceramic element in a vessel containing a fluid, the fluid including water, such that the piezo electric ceramic element is at least partially submerged in the fluid; and
driving the piezo electric ceramic element with an oscillating signal.

23. The method of claim 22, wherein the piezo electric ceramic element includes a substrate and a piezo electric ceramic membrane affixed to the substrate.

24. The method of claim 23, wherein driving the piezo electric ceramic element includes driving the piezo electric ceramic membrane with a first oscillating signal and driving the substrate with a second oscillating signal.

25. The method of claim 22, wherein the fluid comprises chiefly water.

26. The method of claim 22 further comprising directing fluid into the vessel from an intake port.

27. The method of claim 26 further comprising monitoring a fluid level within the vessel.

28. The method of claim 27 further maintaining a predetermined level of fluid within the vessel.

29. The method of claim 22 further comprising removing gases from the vessel into a gas collection compartment through a first gas permeable filter, the gases including hydrogen and oxygen.

30. The method of claim 29 further comprising removing hydrogen from the gas collection compartment through a second gas permeable filter.

31. The method of claim 29 further comprising removing oxygen from the gas collection compartment through a third gas permeable filter.

32. The method of claim 29 further comprising monitoring a flow of at least one of hydrogen or oxygen through the gas collection compartment.

33. The method of claim 22, wherein the oscillating signal comprises an electronic signal having at least on of a predetermined frequency and a predetermined amplitude.

34. A method of producing hydrogen, the method comprising:
placing a plurality of piezo electric ceramic elements in a vessel containing a fluid, the fluid including water, such that the piezo electric ceramic elements are at least partially submerged in the fluid;
driving the piezo electric ceramic elements with one or more oscillating signals; and
removing gases produced by the driving step from the vessel into a gas collection compartment through a first gas permeable filter, the gases including hydrogen and oxygen.

35. The method of claim 34, wherein each piezo electric ceramic element includes a substrate and a piezo electric ceramic membrane affixed to the substrate.

36. The method of claim 35, wherein driving the piezo electric ceramic elements includes, for one of the piezo electric ceramic elements, driving the piezo electric ceramic membrane with a first oscillating signal and driving the substrate with a second oscillating signal.

37. The method of claim 34 further comprising:
arranging the piezo electric ceramic elements into a plurality of stacks;
driving the piezo electric ceramic elements in a first stack with a first oscillating signal; and
driving the piezo electric ceramic elements in the other stacks with a second oscillating signal.

38. The method of claim 34, wherein the fluid comprises chiefly water.

39. The method of claim 34 further comprising directing fluid into the vessel from an intake port.

40. The method of claim 39 further comprising monitoring a fluid level within the vessel.

41. The method of claim 39 further maintaining a predetermined level of fluid within the vessel.

42. The method of claim 34 further comprising removing hydrogen from the gas collection compartment through a second gas permeable filter.

43. The method of claim 34 further comprising removing oxygen from the gas collection compartment through a third gas permeable filter.

44. The method of claim 34 further comprising monitoring a flow of at least one of hydrogen or oxygen through the gas collection compartment.

45. The method of claim 34, wherein the oscillating signal comprises an electronic signal having at least on of a predetermined frequency and a predetermined amplitude.

46. A system for providing hydrogen as a consumable fuel, the system comprising:
a molecular hydrogen generator comprising:
a housing including a conversion compartment and a gas collection compartment fluidly connected to the conversion compartment, wherein the gas collection compartment includes a hydrogen outlet port regulated by a hydrogen filter, and an oxygen outlet port regulated by an oxygen filter, and wherein the conversion compartment includes a fluid intake valve and a fluid drainage valve;
a filter disposed between the conversion compartment and the gas collection compartment, wherein the filter is permeable to select molecules;
an energizer module adapted to generate one or more oscillating signal; and
a plurality of piezo electric ceramic elements disposed within the conversion compartment, each piezo electric ceramic element being electronically coupled to the energizer module to receive one of the oscillating signals;
a fluid supply tank fluidly coupled to the fluid intake valve;
a hydrogen reservoir tank fluidly connected to the hydrogen outlet port;
a gas valve fluidly coupled between the hydrogen reservoir tank and an engine;
command and control module electronically coupled to the molecular hydrogen generator, to the fluid supply tank, to the hydrogen reservoir tank, and to the gas valve, wherein the command and control module is adapted to electronically control production of hydrogen by the molecular hydrogen generator and the supply of hydrogen from the hydrogen reservoir tank to the engine.

47. A method of providing hydrogen as a consumable fuel, the method comprising:
placing a plurality of piezo electric ceramic elements in a vessel containing a fluid, the fluid including water, such that the piezo electric ceramic elements are at least partially submerged in the fluid;
driving the piezo electric ceramic elements with one or more oscillating signals;
removing gases produced by the driving step from the vessel into a gas collection compartment through a first gas permeable filter, the gases including hydrogen and oxygen;
drawing hydrogen gas from the collection compartment into a reservoir tank;
regulating a density of hydrogen within the reservoir tank; and
regulating hydrogen output from the reservoir tank to an engine, wherein the engine is adapted to use the hydrogen as a consumable fuel.
